(19) United States
(12) Patent Application Publication
(10) Pub. No.: US 2005/0013767 A1
(43) Pub. Date: Jan. 20, 2005

(54) Method of delivering a reversible hydrogen storage fuel to a mobile or stationary fuel source

(76) Inventors: Larry David Bagzis, Allentown, PA (US); John Bruce Appleby, Shade Gap, PA (US); Guido Peter Pez, Allentown, PA (US); Alan Charles Cooper, Macungie, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 10/833,467

(22) Filed: Apr. 27, 2004

Related U.S. Application Data
(63) Continuation-in-part of application No. 10/430,246, filed on May 6, 2003.

(51) Int. Cl. G01F 11/06

(52) U.S. Cl. 423/648.1

(57) ABSTRACT

Disclosed is a dispenser useful for dispensing a first liquid and retrieving a second liquid comprising a first conduit having an orifice for dispensing the first liquid, and a second conduit having an orifice for retrieving a second liquid in direction countercurrent to the first liquid. Also disclosed are methods for using a dispenser of the invention comprising placing a dispenser in communication with a first compartment and a second compartment, the dispenser comprising a first conduit having an orifice for dispensing the first liquid and a second conduit having an orifice for retrieving a second liquid in direction countercurrent to the first liquid; transferring the first liquid through the first conduit into the first compartment; and transferring the second liquid situated in the second compartment into the second conduit. The invention also relates to the use of the dispenser in a fueling process.

This application is a continuation-in-part of U.S. patent application Ser. No. 10/430,246, filed May, 6, 2003, the entire disclosure of which is incorporated herein by reference.

### 1. FIELD OF THE INVENTION

The present invention is directed to a dispensing device that allows dispensing of a first liquid and retrieval of a second liquid and methods of use thereof. In one embodiment, the dispensing device is used to dispense a first liquid comprising an at least partially hydrogenated pi-conjugated substrate and retrieve a second liquid comprising the pi-conjugates substrate.

### 2. BACKGROUND OF THE INVENTION

Common fuel dispensing devices such as those used to dispense gasoline for automobiles and the like, referred to as gasoline dispensing nozzles, comprise a handle which is in communication with a gasoline supply means, a manual operating lever to control the flow of fuel to the vehicle, and a dispensing conduit for dispensing the gasoline to one or more gasoline tanks on board the vehicle. Common gasoline dispensing nozzles are described in U.S. Pat. No. 5,197,523 to Fink, Jr. et al. and U.S. Pat. No. 5,435,356 Rabinovich.

Such fuel dispensing and on board storage tanks are satisfactory for a fuel such as gasoline, diesel or alcohol, since the by-products of the combustion process are emitted into the atmosphere. However, conventional fuel dispensing and on-board storage tanks are less attractive for recyclable liquid fuels where the spent fuel must be stored on board the vehicle until it can be retrieved and regenerated.

Recyclable liquid fuels that have generated recent interest include liquid aromatic compounds such as benzene, toluene and naphthalene (“the aromatic substrates”), which undergo reversible hydrogenation to form cyclohexane, methylcyclohexane and decalin (“the hydrogenated substrates”), respectively. The hydrogenated substrates are provided to a dehydrogenation system and hydrogen fuel cell where, under suitable conditions, the hydrogenated substrates dehydrogenate to form hydrogen for use by the fuel cell, and the aromatic substrate is recovered. For example, U.S. Pat. No. 6,074,447 to Jensen describes dehydrogenating methylcyclohexane, decalin, dicyclohexyl, and cyclohexane to toluene, naphthalene, biphenyl and benzene, respectively, in the presence of a particular iridium based molecular complex catalyst at preferably 190° C. or higher.

An attractive feature of using a hydrogen carrier based on liquid aromatic compounds is that it offers the possibility of using the existing liquid hydrocarbon-fuel infrastructure for hydrogenating, delivering and storing the liquid-phase hydrogen carrier. In contrast, the delivery and storage of hydrogen as either a cryogenic liquid or a compressed gas would require different methods of storage and transportation. In addition, the use of compressed hydrogen would incur considerable energy costs in compressing the gas as well as potential issues regarding consumers' acceptance of systems that contain hydrogen at such elevated pressures.

In principle, liquid hydrogenated substrates are easily transported using conventional methods for liquid transport and distribution (pipelines, railcars, tanker trucks). Likewise, liquid hydrogenated substrates can be delivered to a mobile or stationary fuel cell using a conventional gasoline dispensing nozzle. At the point of use, a dehydrogenation reaction is carried out to generate hydrogen for use by the fuel cell and the dehydrogenated substrate (i.e., the aromatic substrate). The aromatic substrate is collected in a recovery tank and is later returned to a hydrogenation facility where it is reacted with hydrogen to regenerate the hydrogenated substrate.

Chem. Eng., 21 (March 2003) describes the use of liquid organic hydrides by hydrogenating benzene and naphthalene to form cyclohexane and decalin, and transporting the hydrogenated compounds to user's site.

A process for delivering hydrogen contained by a liquid substrate (“liquid hydride”) to a fuel cell vehicle or a stationary power source using the existing fossil fuel infrastructure is described in G. Pez, Toward New Solid and Liquid Phase Systems for the Containment, Transport and Deliver of Hydrogen,” May 2003, (see http://www.eere.energy.gov/hydrogenandfuelcells/pdfs/solid liquid_carriers_pres_air_prod.p df). The Pez reference describes a process where the liquid substrate is hydrogenated at a hydrogenation plant and the resultant liquid hydride is delivered to a multi-vehicle fueling station or stationary power source using existing gasoline or diesel delivery methods. The Pez reference notes that a lightweight mid-size fuel cell vehicle could be driven about 400 miles on 18 gallons of a liquid hydride having a density of about 1 g/cc and containing 6 wt. % of desorbable hydrogen.

S. Hodoshima et al., Int. J. Hydrogen Energy 28: 1255-1262 (2003) describes using decalin and naphthalene as the hydrogenated substrate and aromatic substrate, respectively. The Hodoshima reference further teaches that naphthalene could be hydrogenated with hydrogen generated by electrolysis of water using renewable energy sources such as windpower.

E. Newsome et al, Int. J. Hydrogen Energy 23: 905-909 (1998) describes using ethylcyclohexane and toluene as the hydrogenated substrate and aromatic substrate, respectively, and further teaches that the liquid hydride could be formed and stored in summer months for use in winter months.

Typically, the hydrogenated substrate is delivered to a storage tank onboard the vehicle with the mobile fuel cell or nearby the stationary fuel cell where it is stored until hydrogen is required. The hydrogenated substrate is then contacted with a suitable dehydrogenation catalyst under dehydrogenation conditions to provide hydrogen for the fuel cell and the corresponding aromatic substrate is directed to a recovery tank (see G. Pez, Toward New Solid and Liquid Phase Systems for the Containment, Transport and Deliver of Hydrogen,” May 2003, http://www.eere.energy.gov/hydrogenandfuelcells/pdfs/solid_liquid_carriers_pres_air_prod.p df). Presumably, when the onboard liquid hydride storage tank is sufficiently empty and/or the recovery tank is sufficiently full, the dehydrogenated form of the liquid carrier is removed from the recovery tank and the liquid hydride is added to the storage tank.

The following relate to methods for storing the hydrogenated substrates and the corresponding aromatic substrates:

Japanese Patent Application Publication No. JP2003321201 A describes a liquid hydride storage and feed system having a storage tank for the liquid hydride and a recovery tank for holding the resultant dehydrogenated form of the liquid carrier. However, the use of a dual tank storage and recovery arrangement for a liquid hydride fuel will require twice the storage volume of a single tank. Accordingly, for applications where space is at a premium (e.g., a vehicular fuel cell) it would be desirable to use a single tank for storing the liquid hydride carrier and the corresponding dehydrogenated liquid carrier.

Japanese Patent Application Publication No. JP2004026582 A describes a liquid fuel storage device having a first compartment for storing the liquid hydride fuel and a second compartment for storing the dehydrogenated form of the liquid carrier where the first and second compartments are separated by a movable barrier.

U.S. Pat. No. 6,544,400 to Hockaday et al. describes a two-chamber storage device comprising a bladder for storing a hydrogen fuel source and a reaction chamber, where an elastic membrane separates the fuel bladder and the reaction chamber.

Using present technology, process for refueling a vehicular fuel cell comprises attaching a liquid hydride fuel dispensing nozzle to the storage compartment to dispense the hydrogenated substrate (see, e.g., U.S. Pat. No. 5,197,523 to Fink, Jr. et al.). Presumably, the aromatic substrate is removed from the recovery tank by “pumping” it out by a separate retrieving means. This complicates the refueling process and increases the refueling time and these would be expected to meet with consumer resistance.

Accordingly, there is a need for a dispenser that can both dispense a first liquid and retrieve a second liquid.

Citation of any reference in Section 2 is not an admission that the reference is prior art to the present application.

### 3. SUMMARY OF THE INVENTION

The present invention relates to a dispenser useful for dispensing a first liquid and retrieving a second liquid.

In one embodiment, the present invention relates to a dispenser for dispensing a first liquid and retrieving a second liquid comprising a first conduit having an orifice for dispensing the first liquid, and a second conduit having an orifice for retrieving a second liquid in direction countercurrent to the first liquid.

The present invention also relates to methods for using a dispenser of the invention for dispensing a first liquid and retrieving a second liquid.

In one embodiment, the invention relates to a process for dispensing a first liquid to a first compartment and retrieving a second liquid situated in a second compartment, comprising:
placing a dispenser in communication with a first compartment and a second compartment, the dispenser comprising a first conduit having an orifice for dispensing the first liquid and a second conduit having an orifice for retrieving a second liquid in direction countercurrent to the first liquid;
transferring the first liquid through the first conduit into the first compartment; and
transferring the second liquid situated in the second compartment into the second conduit.

The present invention also relates to a fueling process. In one embodiment, the invention relates to a fueling process comprising:
placing a dispenser comprising a first conduit having an orifice for dispensing a first liquid comprising an at least partially hydrogenated pi-conjugated substrate and a second conduit having an orifice for retrieving a second liquid comprising a pi-conjugated substrate in flow communication with a first compartment and a second compartment;
transferring a portion of the first liquid residing in the first compartment into a hydrogen generator and contacting the portion of the stored first liquid with a dehydrogenation catalyst under dehydrogenation conditions sufficient to provide hydrogen and the second liquid;
transferring at least a portion of the second liquid into the second compartment;
transferring the first liquid through the first conduit into the first compartment; and
transferring the second liquid through the second conduit.

The details of the invention are set forth in the accompanying figures, detailed description and examples below. Although any methods and materials similar or equivalent to those described herein can be used in the practice or testing of the present invention, illustrative methods and materials are now described. Other features, objects and advantages of the invention will be apparent from the description and from the claims.

### 4. BRIEF DESCRIPTION OF THE DRAWINGS

FIG. 1 depicts an exemplary dispenser of the invention having a dispensing conduit adjacent to a retrieving conduit.

FIG. 2 depicts an exemplary dispenser of the invention having a dispensing conduit that is not adjacent to a retrieving conduit.

FIG. 3a depicts an exemplary dispenser of the invention having a retrieving orifice proximate to the dispenser handle and having a dispensing conduit.

FIG. 3b depicts an exemplary dispenser of the invention having a dispensing orifice proximate to the dispenser handle and having a retrieving conduit.

FIG. 4a depicts an exemplary dispenser of the invention having a dispensing orifice adjacent to a retrieving orifice.

FIG. 4b depicts an exemplary dispenser of the invention having a dispenser orifice adjacent that is not adjacent to a retrieving orifice.

FIG. 5a depicts an exemplary dispenser of the invention having a retrieving orifice that is larger than the dispensing orifice.

FIG. 5b depicts an exemplary dispenser of the invention having a retrieving orifice that is smaller than the dispensing orifice.

FIG. 6a depicts an exemplary dispenser of the invention having a dispenser orifice situated within a retrieving orifice.

FIG. 6b depicts an exemplary dispenser of the invention having a retrieving orifice situated within a dispensing orifice.

FIG. 7 depicts an exemplary embodiment of the invention where a dispenser of the invention is in communication with a tank having a first liquid and second liquid separated by a barrier.

FIG. 8 depicts an exemplary embodiment of the invention where a dispenser of the invention is in communication with a first tank and a second tank.

### 5. DETAILED DESCRIPTION OF THE INVENTION

As noted above, the present invention relates to a dispenser useful for dispensing a first liquid and retrieving a second liquid. The dispenser of the invention provides a safe, convenient and efficient means for dispensing a first liquid and retrieving a second liquid.

In one embodiment, the invention relates to a dispenser for dispensing a first liquid and retrieving a second liquid, comprising a first conduit having an orifice for dispensing the first liquid, and a second conduit having an orifice for retrieving a second liquid in direction countercurrent to the first liquid.

Referring to the drawings, an exemplary dispenser of the present invention for dispensing a first liquid and retrieving a second liquid is generally indicated as 10. The dispenser includes a housing 60. The rear of the housing is connected to a fuel hose 70 in communication with a first liquid supply means, and a return hose 80 in communication with a return second liquid holding means.

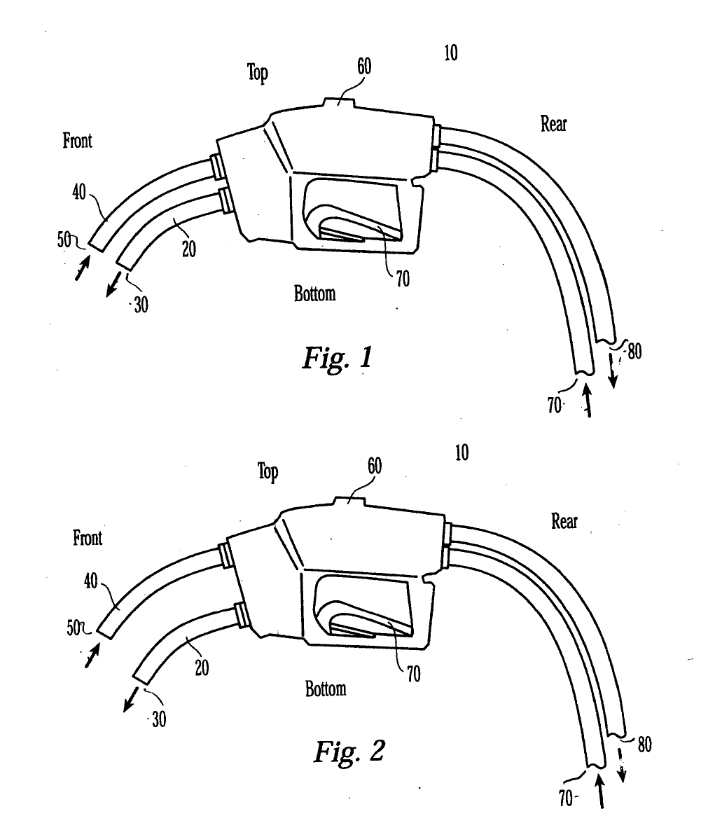

In FIG. 1, the dispenser 10 of the present invention includes a dispensing conduit 20, a dispensing orifice 30, a retrieving conduit 40, and a retrieving orifice 50. The dispensing conduit 20 is in communication with a first compartment (not shown) and the retrieval conduit 40 is in communication with a second compartment (not shown). The dispensing orifice 30 is situated adjacent the retrieving orifice 50. When in use, the first liquid is dispensed into the first compartment from the first conduit 20, and the second liquid in the second compartment is retrieved by the second conduit 40 prior to, simultaneously with or after the dispensing of the first liquid.

In FIG. 2, the dispenser 10 of the present invention includes a dispensing conduit 20, a dispensing orifice 30, a retrieving conduit 40, and a retrieving orifice 50. The dispensing conduit 20 is in communication with a first compartment (not shown) and the retrieval conduit 40 is in communication with a second compartment (not shown). The dispensing conduit 20 and the second conduit 40 are situated in a housing 60, and the first conduit 20 is situated without the second conduit 40. When in use, the first liquid is dispensed into first compartment from the first conduit 20, and the second liquid in the second compartment is retrieved by the second conduit 40 prior to, simultaneously with or after the dispensing of the first liquid.

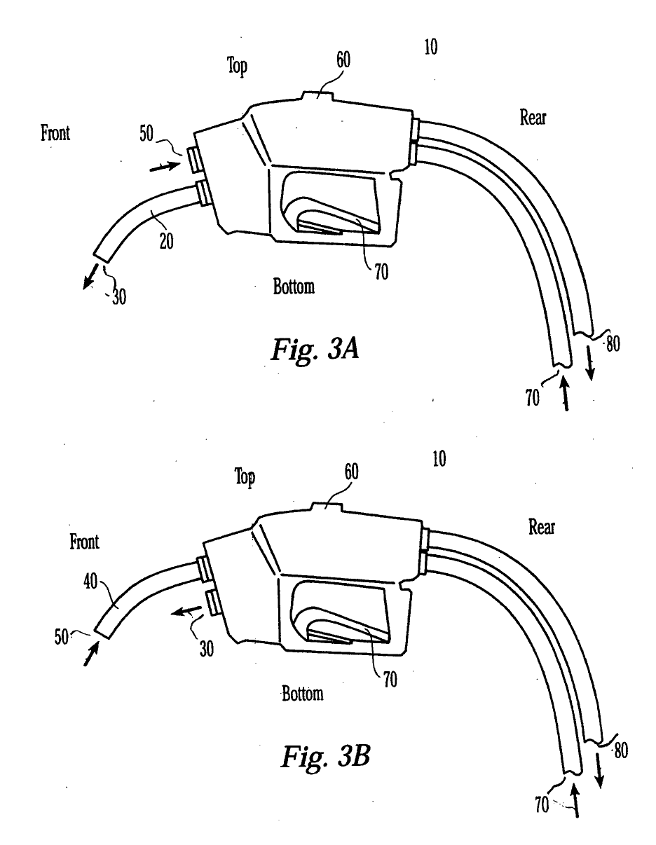

FIG. 3a shows an exemplary dispenser 10 of the present invention that includes a dispensing conduit 20 and a dispensing orifice 30. In FIG. 3a, the retrieving orifice 50 is proximate to the handle 60. The dispensing conduit 20 is in communication with a first compartment (not shown), and the retrieval orifice 50 is in communication with a second compartment (not shown) through an engaging, locking or sealing means (not shown). When in use, the first liquid is dispensed into the first compartment from the first conduit 20, and the second liquid in the second compartment is retrieved by the second orifice 50 conduit 40 prior to, simultaneously with, or after the dispensing of the first liquid. Methods for engaging, locking and sealing are known in the art.

FIG. 3b shows an exemplary dispenser 10 of the present invention that includes a retrieving conduit 40 and a retrieving orifice 50. In FIG. 3b, the dispensing orifice 30 is proximate to the handle 60. The retrieving conduit 40 is in communication with a second compartment (not shown), and the dispensing orifice 30 is in communication with a first compartment through an engaging, locking or sealing means (not shown). When in use, the first liquid is dispensed into the first compartment from the first orifice 30, and the second liquid in the second compartment is retrieved by the second conduit 40 prior to, simultaneously with, or after the dispensing of the first liquid.

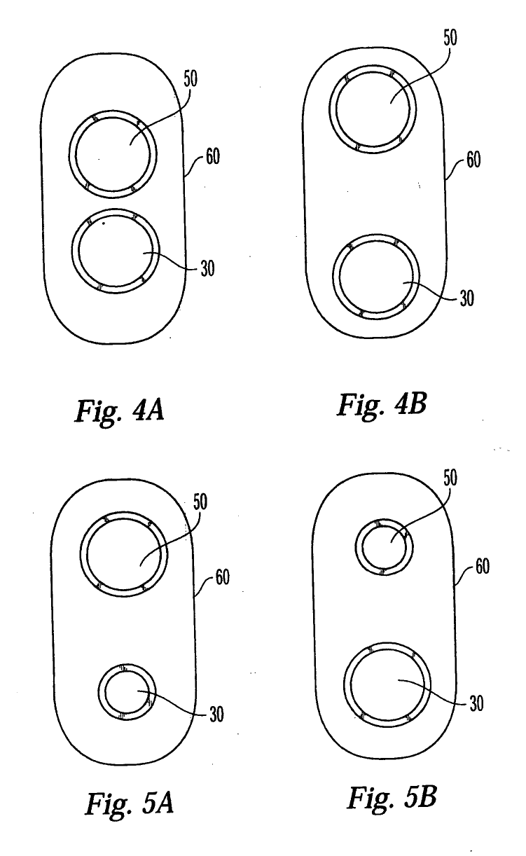

FIG. 4a is a cross-sectional view of the dispensing orifice 30 and retrieving orifice 50 of one embodiment of the dispenser 10 of FIG. 1. The dispensing conduit 20 (not shown) and the dispensing conduit 40 (not shown) are attached to the house 60. In FIG. 4a, the retrieving orifice 50 is adjacent the dispensing orifice 30.

FIG. 4b is a cross-sectional view of the dispensing orifice 30 and retrieving orifice 50 of one embodiment of the dispenser 10 of FIG. 2. The dispensing conduit 20 (not shown) and the dispensing conduit 40 (not shown) are attached to the housing 60. In FIG. 4b, the retrieving orifice 50 is without the dispensing orifice 30.

FIG. 5a is a cross-sectional view of the dispensing orifice 30 and retrieving orifice 50 of one embodiment of the dispenser 10 of FIG. 1. The dispensing conduit 20 (not shown) and the dispensing conduit 40 (not shown) are attached to the housing 60. In FIG. 5a, the diameter of the retrieving orifice 50 is larger than the diameter of the dispensing orifice 30.

FIG. 5b is a cross-sectional view of the dispensing orifice 30 and retrieving orifice 50 of one embodiment of the dispenser 10 of FIG. 1. The dispensing conduit 20 (not shown) and the dispensing conduit 40 (not shown) are attached to the housing 60. In FIG. 5b, the diameter of the retrieving orifice 50 is smaller than the diameter of the dispensing orifice 30.

The dispensers depicted in FIGS. 3a-5a are useful for insuring that the dispensing conduit 20 and/or dispensing orifice 30 are in communication with the first compartment, and the retrieving conduit 40 and/or retrieving orifice 50 are in communication with the second compartment, thereby reducing or eliminating the possibility of, for example, dispersing the first liquid into the second compartment.

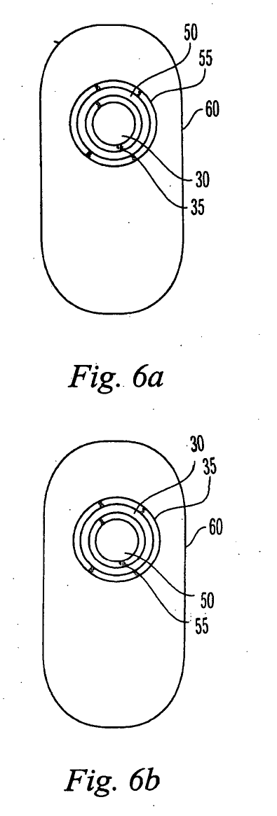

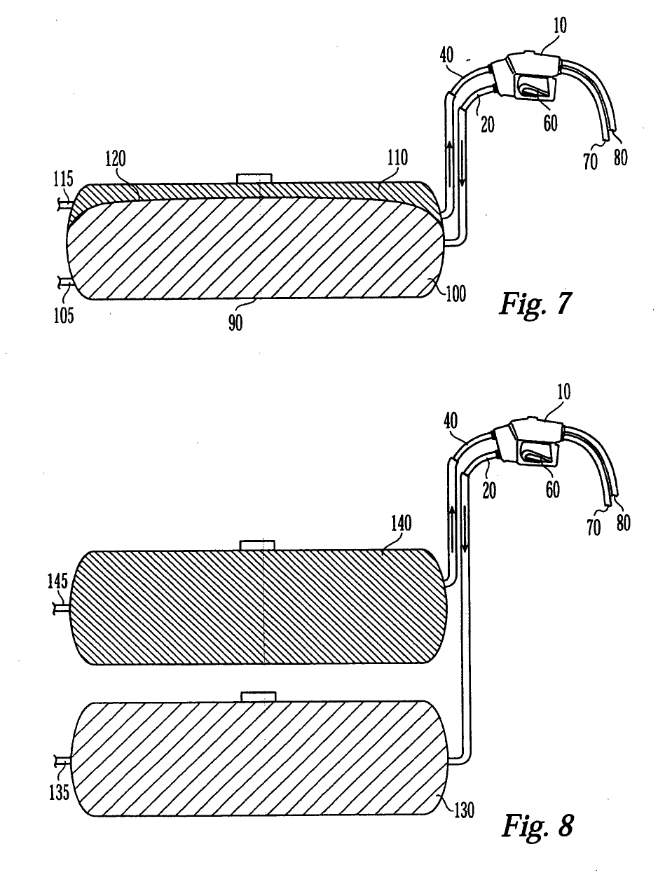

FIG. 6a is a cross-section view of an exemplary embodiment of a dispenser of the invention (not shown) where the dispensing orifice 30 resides within the retrieving orifice 50. The dispensing orifice 30 is partitioned from the retrieving orifice 50 by a partition means 35, and the retrieving orifice is contained within a partition means 55. The partition means 35 and partition means 55 are attached to the housing 60. When in use, the first liquid is dispensed into a first compartment (not shown) from the first orifice 30, and the second liquid in the second compartment (not shown) is retrieved by the second orifice 40 prior to, simultaneously with, or after the dispensing of the first liquid.

FIG. 6b is a cross-section view of an exemplary embodiment of the dispenser of the invention (not shown) the where the retrieving orifice 50 resides within the dispensing orifice 30. The retrieving orifice 50 is partitioned from the dispensing orifice 30 by a partition means 55, and the retrieving orifice is contained within a partition means 35. The partition means 55 and partition means 35 are attached to the housing 60. When in use, the first liquid is dispensed into a first compartment (not shown) from the first orifice 30, and the second liquid in the second compartment (not shown) is retrieved by the second orifice 40 prior to, simultaneously with, or after the dispensing of the first liquid.

Partition means useful in the present invention include those known in the art including, but not limited to hose such as fuel line house, plastic pipe and metal pipe.

The dispensers depicted in FIGS. 6a and 6b are useful for insuring that the dispensing orifice 30 is in communication with the first compartment, and the retrieving orifice 50 is in communication with the second compartment, thereby reducing or eliminating the possibility of, for example, dispersing the first liquid into the second compartment.

FIG. 7 shows an exemplary embodiment of the invention where the dispenser 10 of FIG. 1 is in communication with a tank 90 having a first compartment 100 for a holding a first liquid, and a second compartment 110 for holding a second liquid. A movable barrier 120 separates the first compartment 100 and the second compartment 110. The movable barrier 120 is capable of moving with changes in the volume of the first liquid in compartment 100 and with changes in the volume of the second liquid in compartment 110. The first liquid can be removed from the first compartment 90 by means of a first liquid outlet 105. The second liquid can be delivered to the second compartment 110 by a second liquid inlet 115. When in use, the first liquid is dispensed into the first compartment 100 from the first conduit 20, and the second liquid in the second compartment 110 is retrieved by the second conduit 40 prior to, simultaneously with or after the dispensing of the first liquid.

FIG. 8 shows an exemplary embodiment of the invention where the dispenser 10 of FIG. 1. is communicative with a first tank 130 for holding a first liquid, and a second tank 140 for holding a second liquid. The first liquid can be removed from the first tank 130 by a first liquid outlet 135. The second liquid can be delivered to the second compartment 140 by a second liquid inlet 145. When in use, the first liquid is dispensed into the first compartment 100 from the first conduit 20, and the second liquid in the second compartment 110 is retrieved by the second conduit 40 prior to, simultaneously with or after the dispensing of the first liquid.

The present invention also relates to methods for using a dispenser of the invention for dispensing a first liquid and retrieving a second liquid.

In one embodiment, the invention relates to a process for dispensing a first liquid to a first compartment and retrieving a second liquid situated in a second compartment, comprising:
placing a dispenser in communication with a first compartment and a second compartment, the dispenser comprising a first conduit having an orifice for dispensing the first liquid and a second conduit having an orifice for retrieving a second liquid in direction countercurrent to the first liquid;
transferring the first liquid through the first conduit into the first compartment; and
transferring the second liquid situated in the second compartment into the second conduit.

In another embodiment, the first conduit and the second conduit are situated in a housing and the first conduit is situated without the second conduit.

In one embodiment, the first orifice is inserted into an orifice on a first compartment.

In another embodiment, the second orifice is immersed in a second liquid and the second liquid is retrieved. In another embodiment, the second orifice is immersed into a second liquid residing in a second compartment, and the second liquid is retrieved.

In one embodiment, the second liquid is transferred from the second conduit into a receiving tank.

In another embodiment, the transferring of the first liquid and the transferring of the second liquid are simultaneously conducted.

In another embodiment, the transferring of the first liquid is initiated prior to transferring the second liquid.

In another embodiment, the transferring of the first liquid is initiated after transferring the second liquid.

Compartments useful in combination with the device of the invention are known in the art and include, but are not limited to, dual tanks; single tanks having a compartment for a first liquid and a compartment for a second liquid separated by an immovable barrier; and single tanks having a compartment for a first liquid and a compartment for a second liquid separated by an movable barrier.

The use of a single tank having a compartment for the first liquid and compartment for a second compartment separated by a movable barrier are particularly useful where space is limited, e.g., on a vehicle powered by a hydrogen fuel cell using a liquid hydride carrier. In such applications, the second liquid (e.g., the dehydrogenated carrier) can be envisioned as “occupying” the volume of the first liquid. Non-limiting examples of single tanks having first liquid compartment and a second liquid compartment are known and include, but are not limited to, compartments separated by a movable barrier; compartments separated by a bladder where the first liquid is contained within the bladder and the second liquid is contained in the tank on the outside of the bladder; compartments separated by a bladder where the first liquid is contained within the bladder and the second liquid is contained in the tank on the outside of the bladder; or compartments separated by an impermeable membrane (see U.S. Pat. No. 6,544,400 to Hockaday et al.).

In one embodiment, the first compartment and the second compartment are separated by an expandable bladder.

In another embodiment, the first compartment and the second compartment are separated by an impermeable membrane.

When the first and second compartments are separated by a movable barrier, the dispensing of the first fluid can cause displacement of the second fluid. In one embodiment, the invention relates to a process for dispensing a first liquid comprising, placing a dispenser in communication with a first compartment having a first liquid and a second compartment having a second liquid, where the first and second compartments are separated by a movable barrier, and the dispenser comprises a first conduit having an orifice for dispensing the first liquid and a second conduit having an orifice for retrieving a second liquid in direction countercurrent to the first liquid, transferring the first liquid through a first conduit into a first compartment; and retrieving the second liquid situated in the second compartment into a second conduit, wherein the increasing volume of the first liquid in the first compartment causes the displacement of the second liquid from the second compartment and into the second conduit.

Any first or second liquid can be dispensed or retrieved with the device of the invention provided the liquids are compatible with the dispensing/retrieving device and its associated components. Materials useful for the dispensing/retrieving device and its associated components will be chemically inert to the liquids, not degrade at the operating temperature, and not rupture or leak at the operating pressures. Suitable materials of construction are known in the art.

As used herein, the term “liquid” refers to any material that can be made to flow through the dispenser including, but not limited to, solutions, suspensions, emulsions, dispersions, and melts. In general, liquids useful in the present invention will have a viscosity of up to about 2000 cSt (centistokes) at the operating temperature of the dispenser. The material need not be a liquid at ambient temperature, e.g., 25° C. For example, in certain embodiments, the material may be made to flow after heating, e.g., forming a melt.

Non-limiting examples of first liquids that can be dispensed with the dispenser of the invention include aqueous liquids such as acidic liquids, basic liquids, liquids having a pH of about 7, bodily fluids such as blood, and fluids comprising a medicament such as an active agent for treating or preventing a medical condition; at least partially hydrogenated pi-conjugated substrates as defined below; linear and branch-chain hydrocarbons such as (C₃-C₂₀)alkanes, (C₃-C₂₀)alkenes and (C₃-C₂₀)alkynes, each of which can by unsubstitued or substituted with one or more —R₁; cyclic hydrocarbons such as cyclopentane, cyclohexane, cycloheptane, and decalin, each of which can by unsubstitued or substituted with one or more —R₂; aromatic hydrocarbons such as benzene, toluene, xylenes, mesitylenes, and naphthalene, each of which can by unsubstitued or substituted with one or more —R₂; liquid fossil fuels such as gasoline, heating oil no. 2 (i.e., diesel fuel), aviation fuel, and liquified coal; glycols such ethylene glycol and propylene glycol; silicone fluids; ionic liquids; and any mixture of two or more of the foregoing, wherein R₁ is —OH, —OR₂, —C(O)R, —C(O)OR₂, —OC(O)R₂, —OC(O)OR₂, ═O, ═S, —C≡N, —NH₂, —NHR, —NR₂, and; and R₂ is a linear or branched alkyl.

Non-limiting examples of second liquids that can be retrieved by the dispenser of the invention include those described above for the first liquids. Other non-limiting examples of second liquids include spent process fluids from chemical processes; degraded fluids such as used motor oil; pi-conjugated substrates as defined below; and fluids containing contaminants such as sewage or animal waste fluids (e.g., urine).

Means for dispensing the first liquid include methods known in the art such as gravity; application of pressure to the first liquid to force the liquid out of the first orifice; sealing the first orifice to an orifice on the first compartment and evacuating the first compartment to draw the first liquid into the first compartment; or any combination of two or more of the foregoing.

Means for retrieving the second liquid include methods known in the art and those methods described above including gravity; immersing the second orifice into a second liquid and using vacuum to draw the second liquid into the second orifice; sealing the second orifice to an orifice on a second compartment and using pressure to force the second liquid out of the compartment and into the second orifice; or any combination of two or more of the foregoing.

In one embodiment, prior to dispensing, the first liquid is heated to temperature sufficient to allow the first liquid to be dispensed through the dispenser orifice.

In another embodiment, prior to retrieval, the second liquid is heated to temperature sufficient to allow the second liquid to be retrieved through the retrieval orifice.

When the first or second liquid is heated, the temperature of the first or second liquid may range up to about 250° C. In another embodiment, when the first or second liquid is heated, the temperature of the first or second liquid may range up to about 200° C. In another embodiment, when the first or second liquid is heated, the temperature of the first or second liquid may range may range up to about 100° C.

In one embodiment, the first liquid is an at least partially hydrogenated pi-conjugated substrate and the second liquid is a pi-conjugated substrate.

As used herein, the phrase “pi-conjugated substrate” refers to an unsaturated compound such as, e.g., an aromatic compound.

As used herein, the phrase “at least partially hydrogenated pi-conjugated substrate” refers to a pi-conjugated substrate that has been at least partially hydrogenated, e.g., by catalytic hydrogenation of the pi-conjugated substrate.

Non-limiting examples of useful pi-conjugated substrates include small ring aromatic carbocycles and fused ring carbocycles having up to three fused rings including benzene, toluene, naphthalene and anthracene; heterocycle analogs of the small ring aromatic carbocycles and fused ring carbocycles having up to three fused rings where at least one of the carbon ring atoms is replaced by a heteroatom selected from the group consisting of B, N, O, P, Si, S or any combination of two or more of the foregoing; phenyl-substituted silanes, aryl-substituted oligomers and low molecular weight polymers of ethylene, oligomers of aryl- and vinyl-substituted siloxanes where the aryl groups are phenyl, tolyl, naphthyl and anthracyl groups (see JP2002134141 A); and low molecular weight polymers of phenylene (see JP2002134141 A); and any combination of two or more of the foregoing.

Other non-limiting examples of useful pi-conjugated substrates include extended pi-conjugated substrates selected from the group consisting of extended polycyclic aromatic hydrocarbons, extended pi-conjugated substrates with nitrogen heteroatoms, extended pi-conjugated substrates with heteroatoms other than nitrogen, pi-conjugated organic polymers and oligomers, ionic pi-conjugated substrates, pi-conjugated monocyclic substrates with multiple nitrogen heteroatoms, pi-conjugated substrates with at least one triple bonded group, a pitch, and any combination of two or more of the foregoing as described in our copending U.S. patent application Ser. No. ______, filed on Apr. 27, 2004, entitled “Hydrogen Storage by Reversible Hydrogenation of Pi-Conjugated Substrates,” the entire contents of which are incorporated herein by reference.

In one embodiment, the pi-conjugated substrate is an extended polycyclic aromatic hydrocarbon selected from the group consisting of pyrene, perylene, coronene, ovalene, picene and rubicene, fluorene, indene and acenanaphthylene, pyranthrone; and any combination of two or more of the foregoing

In another embodiment, the pi-conjugated substrate is a pi-conjugated aromatic molecule comprising five membered rings selected from the group consisting of fluorene, indene, acenanaphthylene, and any combination of two or more of the foregoing.

In another embodiment, the pi-conjugated substrate is an extended pi-conjugated substrate (EPAH) with nitrogen heteroatom selected from the group consisting of phenanthroline, quinoline, N-methylindole, 1,2-dimethylindole, 1-ethyl-2-methylindole; carbazole, N-methylcarbazole, N-ethylcarbazole, N-n-propylcarbazole N-iso-propylcarbazole; acridine; indolo[2,3-b]carbazole, indolo[3,2-a]carbazole 1,4,5,8,9,12-hexaazatriphenylene, pyrazine[2,3-b]pyrazine, N,N′,N″-trimethyl-6,11-dihydro-5H-diindolo[2,3-a:2′,3′-c]carbazole, 1,7-dihydrobenzo[1,2-b:5,4-b′]dipyrrole, 4H-benzo[def]carbazole; and any combination of two or more of the foregoing.

In another embodiment, the pi-conjugated substrate is a pi-conjugated aromatic molecules comprising six and five membered rings with nitrogen or oxygen heteroatoms in the five membered ring structure is an extended pi-conjugated substrate with heteroatoms other than nitrogen selected from the group consisting of dibenzothiaphene, phosphindole, P-methoxyphosphindole, P-methylphosphindole, dimethylsilaindene, boraindole, borafluorene, methylboraindole; and any combination of two or more of the foregoing.

In another embodiment, the pi-conjugated substrate is a pi-conjugated organic polymer or oligomer selected from the group consisting of polypyrrole, polyindole, poly(methylcarbazole), polyaniline, poly(9-vinylcarbazole), and any combination of two or more of the foregoing.

In another embodiment, the pi-conjugated substrate is a pi-conjugated monocyclic substrate with multiple nitrogen heteroatoms selected from the group consisting of pyrazine, N-methylimidazole; and any combination thereof.

In another embodiment, the pi-conjugated substrate is an ionic pi-conjugated substrate selected from the group consisting of N-lithiocarbazole, N-lithioindole, N-lithiodiphenylamine, N-sodiumcarbazole, N-potassiumcarbazole, the tetramethylammonium salt of carbazole; and any combination of two or more of the foregoing.

In another embodiment, the pi-conjugated substrate is a pi-conjugated substrate with at least one triple bonded group selected from the group consisting of terephthalonitrile (1,4-dinitrilobenzene), benzonitrile, 1,3,5-trinitrilobenzene; and any combination of two or more of the foregoing.

In another embodiment, the pi-conjugated substrate is a pitch, which may by a natural pitch or a synthetic pitch. The prepared pitch compositions have softening points that range from 63° C. to 114° C. In one embodiment, the extended pi-conjugated substrate useful in the process of the invention is a pitch or pitch fraction selected from the group consisting of natural pitch, synthetic pitch, synthetic pitch containing molecules with nitrogen heteroatoms, and combinations thereof.

In one embodiment, an additive such as a low volatility hydrocarbon fluid or some of the hydrogenated liquid EPAH is added to the extended pi-conjugated fluid to increase their fluidity.

The introduction of n-alkyl, alkyl, alkoxy, ether or polyether groups as substituents on the ring structures of the polycyclic aromatic molecules, particularly the use such substituents of varying chain lengths up to about 12 carbon atoms, can lower their melting points, but at some cost in “dead weight” and reduced sorbed hydrogen capacity of the systems. Also, certain substituents, e.g., nitrites and alkynes, can provide additional sorbed hydrogen capacity since each nitrile group can accommodate two molar equivalents of hydrogen.

In another embodiment, the pi-conjugated substrate is a mixture of two or more components, one or more of which comprises a pi-conjugated substrate. In some cases, mixtures may form a eutectic mixture. For instance chrysene (1,2-benzophenanthrene, m.p. 250° C.) and phenanthrene, (m.p. 99° C.) are reported to form a eutectic melting at 95.5° C. and for the 3-component system consisting of chrysene, anthracene and carbazole (m.p. 243° C.), a eutectic is observed at 192° C. (Pascal, Bull.Soc.Chim.Fr. 1921, 648).

In one embodiment, the mixture of at least two different at least partially hydrogenated pi-conjugated substrates is a eutectic mixture.

In another embodiment, the eutectic mixture comprises a mixture of an extended pi-conjugated substrate with nitrogen heteroatoms, an extended pi-conjugated substrate with heteroatoms other than nitrogen, and any combination thereof.

In another embodiment, the eutectic mixture comprises N-methylcarbazole, N-ethylcarbazole, N-propylcarbazole, N-isopropylcarbazole, or any combination of two or more of the foregoing.

In another embodiment, the eutectic mixture comprises 1-ethyl-2-methylindole and 1,2-dimethylindole.

The present invention also relates to a liquid refueling process.

In one embodiment, the present invention relates to a fueling process comprising:
placing a dispenser comprising a first conduit having an orifice for dispensing a first liquid comprising an at least partially hydrogenated pi-conjugated substrate and a second conduit having an orifice for retrieving a second liquid comprising a pi-conjugated substrate in flow communication with a first compartment and a second compartment;
transferring a portion of the first liquid residing in the first compartment into a hydrogen generator and contacting the portion of the stored first liquid with a dehydrogenation catalyst under dehydrogenation conditions sufficient to provide hydrogen and the second liquid;
transferring at least a portion of the second liquid into the second compartment;
transferring the first liquid through the first conduit into the first compartment; and
transferring the second liquid through the second conduit.

Dehydrogenation processes suitable for use in the present invention are described in R. O. Loufty and E. M. Vekster, in “Investigation of Hydrogen Storage in Liquid Organic Hydrides”, Proceedings of the International Hydrogen Energy Forum 2000, Munich Germany, 2000; pp. 335-340; U.S. Pat. No. 6,074,447 to Jensen et al.; and Hodoshima et al., Int. J Hydrogen Energy 28: 1255-1262 (2003), the entire contents of each of the aforementioned references being incorporated herein by reference. Dehydrogenation processes useful in the present invention include those carried out at from about 200° C. to 400° C. under “wet-dry multiphase conditions”, which involves intermittently contacting the saturated liquid hydrocarbon with the heated solid catalyst in a way such that the catalyst is alternately wet and dry described by N. Kariya et al., Applied Catalysis A 233: 91-102 (2002), the entire contents of which are incorporated herein by references. A preferred dehydrogenation process is a continuous liquid phase process, where the process is carried out at a temperature below the boiling point of the hydrogenated pi-conjugated substrate and the pi-conjugated substrate (see our copending U.S. patent application Ser. No. ______, filed on Apr. 27, 2004, entitled “Hydrogen Storage by Reversible Hydrogenation of Pi-Conjugated Substrates,” the entire contents of which are incorporated herein by reference). When used in connection with the dehydrogenation process, the phrase “at a temperature below the boiling point of the hydrogenated pi-conjugated substrate and pi-conjugated substrate” means that the process is carried at sufficient pressure to prevent the hydrogenated pi-conjugated substrate and the pi-conjugated substrate from boiling at the reaction temperature.

The present invention is not to be limited in scope by the specific embodiments disclosed above, which are intended as illustrations of a few aspects of the invention and any embodiments that are functionally equivalent are within the scope of this invention. Indeed, various modifications of the invention in addition to those shown and described herein will become apparent to those skilled in the art and are intended to fall within the scope of the appended claims.

A number of references have been cited, the entire disclosures of which are incorporated herein by reference.

1. A dispenser for dispensing a first liquid and retrieving a second liquid comprising a first conduit having a first orifice for dispensing the first liquid and a second conduit having a second orifice for retrieving the second liquid in direction countercurrent to the first liquid.

2 The dispenser of claim 1 wherein the first conduit and the second conduit are situated in a housing and the first orifice is situated adjacent to the second orifice.

3. The dispenser of claim 1 wherein the first conduit and the second conduit are situated in a housing and the first conduit is situated without the second conduit.

4. The dispenser of claim 1 or claim 2 wherein the orifice of the first conduit is fitted with a means for engaging, locking and sealing the first orifice to a first compartment for receiving the first liquid in a direction countercurrent to the second liquid.

5. The dispenser of claim 1 or claim 2 wherein in the orifice of the second conduit is fitted with a means for engaging, locking and sealing the second orifice to a second compartment for retrieving the second liquid in a direction counter current to the first liquid.

6. The dispenser of claim 1 wherein the retrieving orifice resides within the dispensing orifice.

7. The dispenser of claim 1 wherein the dispensing orifice resides within the retrieving orifice.

8. A process for dispensing a first liquid to a first compartment and retrieving a second liquid situated in a second compartment, comprising:
placing a dispenser in communication with a first compartment and a second compartment, the dispenser comprising a first conduit having an orifice for dispensing the first liquid and a second conduit having an orifice for retrieving a second liquid in direction countercurrent to the first liquid;
transferring the first liquid through the first conduit into the first compartment; and
transferring the second liquid situated in the second compartment into the second conduit.

9. The process of claim 8 further comprising transferring the second liquid from the second conduit into a receiving tank.

10. The process of claim 8 wherein the transferring of the first liquid and the transferring of the second liquid are simultaneously conducted.

11. The process of claim 8 wherein the transferring of the first liquid is initiated prior to transferring the second liquid.

12. The process of claim 8 wherein the first compartment and the second compartment are separated by an expandable bladder.

13. The process of claim 8 wherein the first compartment and the second compartment are separated by an impermeable membrane.

14. A fueling process comprising:
placing a dispenser comprising a first conduit having an orifice for dispensing a first liquid comprising an at least partially hydrogenated pi-conjugated substrate and a second conduit having an orifice for retrieving a second liquid comprising a pi-conjugated substrate in flow communication with a first compartment and a second compartment;
transferring a portion of the first liquid residing in the first compartment into a hydrogen generator and contacting the portion of the stored first liquid with a dehydrogenation catalyst under dehydrogenation conditions sufficient to provide hydrogen and the second liquid;
transferring at least a portion of the second liquid into the second compartment;
transferring the first liquid through the first conduit into the first compartment and transferring the second liquid through the second conduit.

15. The process of claim 14 wherein the transferring of the first liquid and the transferring of the second liquid are simultaneously conducted.

16. The process of claim 14 wherein the transferring of the first liquid is initiated prior to transferring the second liquid.

17. The process of claim 14 wherein the first liquid and the second liquid have a boiling point above the dehydrogenation conditions.

18. The process of claim 14 wherein the first compartment and the second compartment are separated by an expandable bladder.

19. The process of claim 14 wherein the first compartment and the second compartment are separated by a semi-permeable membrane.

20. The process of claim 14, wherein the pi-conjugated substrate is an extended pi-conjugated substrate selected from the group consisting of extended polycyclic aromatic hydrocarbons, extended pi-conjugated substrates with nitrogen heteroatoms, extended pi-conjugated substrates with heteroatoms other than nitrogen, pi-conjugated organic polymers and oligomers, ionic pi-conjugated substrates, pi-conjugated monocyclic substrates with multiple nitrogen heteroatoms, pi-conjugated substrates with at least one triple bonded group, a pitch, and any combination of two or more of the foregoing.

21. The process of claim 20, wherein the pi-conjugated substrate is an extended polycyclic aromatic hydrocarbon selected from the group consisting of pyrene, perylene, coronene, ovalene, picene and rubicene, fluorene, indene and acenanaphthylene, pyranthrone; and any combination of two or more of the foregoing.

22. The process of claim 20, wherein the pi-conjugated substrate is an extended pi-conjugated substrates with nitrogen heteroatom selected from the group consisting of phenanthroline, quinoline, N-methylindole, 1,2-dimethylindole, 1-ethyl-2-methylindole; carbazole, N-methylcarbazole, N-ethylcarbazole, N-n-propylcarbazole N-iso-propylcarbazole; acridine; indolo[2,3-b]carbazole, indolo[3,2-a]carbazole 1,4,5,8,9,12-hexaazatriphenylene, pyrazine[2,3-b]pyrazine, N ,N′,N″-trimethyl-6,11-dihydro-5H-diindolo[2,3-a:2′,3′-c]carbazole, 1,7-dihydrobenzo[1,2-b:5,4-b′]dipyrrole, 4H-benzo[def]carbazole; and any combination of two or more of the foregoing.

23. The process of claim 20, wherein the extended pi-conjugated substrate is an extended pi-conjugated substrate with heteroatoms other than nitrogen selected from the group consisting of dibenzothiaphene, phosphindole, P-methoxyphosphindole, P-methylphosphindole, dimethylsilaindene, boraindole, borafluorene, methylboraindole; and any combination of two or more of the foregoing.

24. The process of claim 20, wherein the extended pi-conjugated substrate is a pi-conjugated organic polymer or oligomer selected from the group consisting of polypyrrole, polyindole, poly(methylcarbazole), polyaniline, poly(9-vinylcarbazole); and any combination of two or more of the foregoing.

25. The process of claim 20, wherein the extended pi-conjugated substrate is an ionic pi-conjugated substrates selected from the group consisting of N-lithiocarbazole, N-lithioindole, N-lithiodiphenylamine, N-sodiumcarbazole, N-potassiumcarbazole, the tetramethylammonium salt of carbazole; and any combination of two or more of the foregoing.

26. The process of claim 20, wherein the extended pi-conjugated substrate is a pi-conjugated monocyclic substrates with multiple nitrogen heteroatoms selected from the group consisting of pyrazine, N-methylimidazole; and any combination thereof.

27. The process of claim 20, wherein the extended pi-conjugated substrate is a pi-conjugated substrate with at least one triple bonded group selected from the group consisting of terephthalonitrile (1,4-dinitrilobenzene), benzonitrile, 1,3,5-trinitrilobenzene; and any combination of two or more of the foregoing.

28. The process of claim 20, wherein the extended pi-conjugated substrate is a pitch or pitch fraction selected from the group consisting of natural pitch, synthetic pitch, synthetic pitch containing molecules with nitrogen heteroatoms, and combinations thereof.

29. The process of claim 14, wherein the pi-conjugated substrate is selected from the group consisting of a small ring aromatic carbocycle or fused ring aromatic carbocycle having up to three fused carbocylic rings; heterocycle analogs of the small ring aromatic carbocycle or fused ring aromatic carbocycle having up to three fused aromatic rings; a phenyl-substituted silane; a aryl-substituted oligomer or low molecular weight polymer of ethylene; a polymer or oligomer of aryl- and vinyl-substituted siloxane; and a low molecular weight polymer of phenylene.

30. The process of claim 29, wherein the pi-conjugated substrate is small ring aromatic carbocycle or a fused ring aromatic carbocycle having up to three fused aromatic carbocyclic rings selected from the group consisting of benzene, toluene, naphthalene, anthracene, and combination of two or more of the foregoing.

31. The process of claims 29, wherein the pi-conjugated substrate is a polymer or oligomer of an aryl-substituted siloxane, wherein the aryl group is selected from the group consisting of -phenyl, -tolyl, -naphthyl and -anthracyl or any combination of two or more of the foregoing.

32. The process of claim 14, wherein the at least partially hydrogenated pi-conjugated substrate has boiling point of at least about 200° C.

33. The process of claim 14, wherein the at least partially hydrogenated pi-conjugated substrate has melting point of less than about −10° C.

34. The process of claim 14, wherein the pi-conjugated substrate has boiling point of at least about 200° C.

35. The process of claim 14, wherein the pi-conjugated substrate has melting point of less than about −10° C.

36. The process of claim 14, wherein the at least partially hydrogenated pi-conjugated substrate further comprises a second at least partially hydrogenated pi-conjugated substrate.

37. The process of claim 36, wherein the at least partially hydrogenated extended pi-conjugated substrate and the second at least partially hydrogenated extended pi-conjugated substrate form a eutectic mixture.

38. The process of claim 37, wherein the eutectic mixture comprises N-methylcarbazole, N-ethylcarbazole, N-propylcarbazole, and any mixture of two or more of the foregoing.

39. The process of claim 38, wherein the eutectic mixture comprises 1-ethyl-2-methylindole and 1,2-dimethylindole.

40. The process of claim 37, wherein the eutectic mixture of at least two different at least partially hydrogenated extended pi-conjugated substrates eutectic mixture is a liquid at −10° C.
